(19) United States
(12) Patent Application Publication
(10) Pub. No.: US 2006/0277721 A1
(43) Pub. Date: Dec. 14, 2006

(54) Gel grip member with integral housing portion

(76) Inventors: Christopher A. Barretta, Baltimore, MD (US); Gary D. Fisher, Street, MD (US)

Correspondence Address: HARNESS, DICKEY & PIERCE, P.L.C., P.O. BOX 828, BLOOMFIELD HILLS, MI, 48303, US

(21) Appl. No.: 11/440,299

(22) Filed: May 24, 2006

Related U.S. Application Data
(60) Provisional application No. 60/685,742, filed on May 27, 2005.

(51) Int. Cl. B25G 1/10

(52) U.S. Cl. 16/421

(57) ABSTRACT

The power tool has a gripping member with a base which has a desired configuration with an outer and inner surface. The base has a desired structural rigidity and a skin receiving member. A skin covers the base and has a configuration to mate with the base to provide a pocket between the base and the skin. A gel material is positioned in the pocket. Also, the base includes a mechanism to couple the gripping member with the tool housing.

### CROSS-REFERENCE TO RELATED APPLICATIONS

This application claims the benefit of U.S. Provisional Application No. 60/685,742, filed on May 27, 2005 entitled “Gel Grip Member with Integral Housing Portion”. The disclosure of the above application is incorporated herein by reference.

### FIELD OF THE INVENTION

The present invention relates to power tools and, more specifically, to power tools which include gel members that are an integral part of the housing.

### BACKGROUND AND SUMMARY OF THE INVENTION

When utilizing hand tools, depending upon the use, vibration is created during use of the tool. The vibration, which is created during use, is fed back directly to the user. Thus, the user's hands, wrists, elbow, etc., absorbs the vibrational shock during use. Accordingly, it would be desirable to provide a hand tool which, during use, reduced vibration.

U.S. Patent Application No. 2004/0078936, assigned to the same assignee as the present invention, provides a gel grip to dampen vibration. In this invention, the handle includes a blister pack which includes the vibration dampening gel. The gel is vacuum formed or heat sealed in a bladder. Thus, the bladder ordinarily necessitates mounting onto a substantially flat planar surface, and must be accommodated as such. While the application works satisfactorily for its intended purpose, designers are always striving to improve the art.

Accordingly, the present disclosure provides the art with a gel handle portion which can be configured into a desired configuration. The gel member can fit around corners and provide gel surfaces on surfaces which have complex configurations where the surfaces angled with respect to one another. The present disclosure provides a base which is rigidly attached to the housing and is a part of the housing. The present disclosure includes structure to attach to the inside of the tool housing.

According to the first aspect of the disclosure, a gripping member comprises a base having a desired configuration with an outer and inner surface. The base has a desired structural rigidity and a skin receiving member on the base inner surface. The gripping member includes a skin to cover the base. The skin has a desired configuration to provide a pocket between the base and the skin. The skin has a member which is received in the base inner surface receiving member. A gel material is positioned in the pocket between the base and the skin. Also, the base includes a mechanism to couple it with a tool housing. The base receives the skin member in a peripheral groove. The skin member has a peripheral lip or bead which is frictionally fit into the peripheral groove. The base has a peripheral flange and the skin surrounds the inner and outer surface of the flange. The skin has a mating configuration with the base and is slightly larger to form the pocket. The base forms a portion of the housing when the base is coupled with the housing.

Accordingly to a second aspect of the disclosure, a power tool comprises a housing with a pair of housing members coupled together. A motor is positioned within the housing. An output is coupled with the motor. A power source is coupled with the housing. An actuation member is coupled with the motor and the power source to activate and deactivate the motor which, in turn, drives the output. A gripping member is positioned with the housing. The gripping member comprises a base with a desired configuration with an outer and inner surface. The base has a desired structural rigidity and a skin receiving member on the base inner surface. The gripping member includes a skin to cover the base. The skin has a desired configuration to provide a pocket between the base and the skin. The skin has a member which is received in the base inner surface. A gel material is positioned in the pocket between the base and the skin. Also, the base includes a mechanism to couple it with the tool housing. The base receives the skin member in a peripheral groove. The skin member is a peripheral lip or bead which is frictionally fit into the peripheral groove. The base has a peripheral flange and the skin surrounds the inner and outer surface of the flange. The skin has a mating configuration with the base and is slightly larger to form the pocket. The base forms an integral portion of the housing. The outer periphery of the base nests in the housing opening.

According to a third aspect of the disclosure, a method of forming a gripping member comprises injection molding an elastic material to form a skin. A base is injection molded to form a rigid member. The base, if desired, is coated with a metallic material. The skin is stretched to cover the base. A filling port and vent port are formed into the base. A gel material is mixed and injected into a pocket formed between the skin and the base. During injection, air escapes through the vent port. If necessary, the assembly is heated to cure the gel. The assembly is held in a fixture to maintain the desired skin shape while the gel is cured. After curing, the ports are sealed by heat staking to eliminate the ports. After forming the gripping member, it may be assembled or fastened onto the housing of a power tool.

From the following detailed description taken in conjunction with the accompanying drawings and claims, other objects and advantages of the present disclosure will become apparent to those skilled in the art.

### BRIEF DESCRIPTION OF THE DRAWINGS

The present teaching will become more fully understood from the detailed description and the accompanying drawings, wherein:

FIG. 1 is a perspective view of a power tool in accordance with the present invention.

FIG. 2 is a perspective rear view of a gel member housing portion of the present invention.

FIG. 3 is an exploded perspective view of the housing including the gel portion.

FIG. 4 is an exploded view of the gel housing portion.

FIG. 5 is a cross-section view of FIG. 1 along line 5-5 thereof.

### DETAILED DESCRIPTION OF THE PREFERRED EMBODIMENTS

The following description of the preferred embodiment(s) is merely exemplary in nature and is in no way intended to limit the disclosure, its application, or uses.

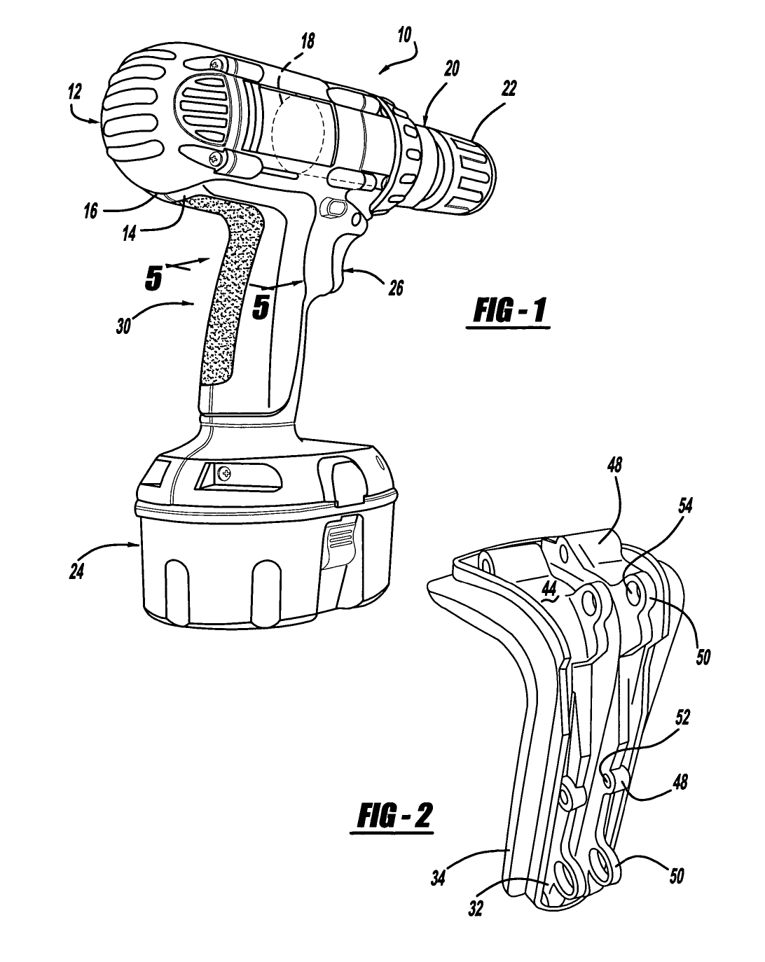

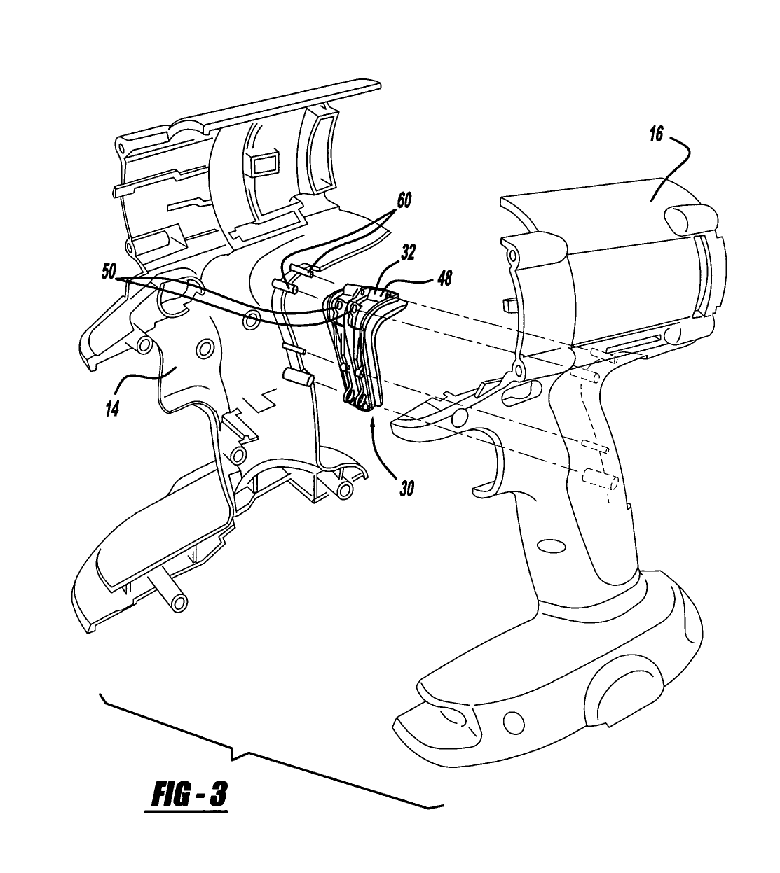

Turning to the figures, particularly FIG. 1, a power tool is illustrated and designated with the reference numeral 10. The power tool includes a housing 12 which includes a pair of housing members 14 and 16. A motor 18 is positioned inside the housing 12 driving an output 20. The output 20 includes a chucking member 22 at the end of the output 20. Also, a power source 24, in this instance, a battery, is coupled with the housing 12. The battery 24 is electrically coupled with an activation member 26 which, in turn, is coupled with the motor 18. The activation member 26 activates and deactivates the motor which, in turn, rotates the output 20. A gel gripping portion 30 is coupled with the housing members 14 and 16.

The gel gripping portion 30 includes a base 32, a skin 34, and a gel material 36. The base 32 is formed from a plastic material providing a rigid structure. The base 32 may have a desired configuration and may curve or angle such that a first portion 38 is angled with respect to a second portion 40.

The base 32 has an outer surface 42 and an inner surface 44. The outer surface 42 may include a metallic layer 43 to provide an aesthetic appealing appearance. The metallic layer 43 may be electroplated or otherwise vacuum metallized onto the surface. Ordinarily, a chromium layer is overlaid on the base to provide a metallic appearance through the transparent gel. This provides a silver highly polished surface which provides an aesthetic appearance.

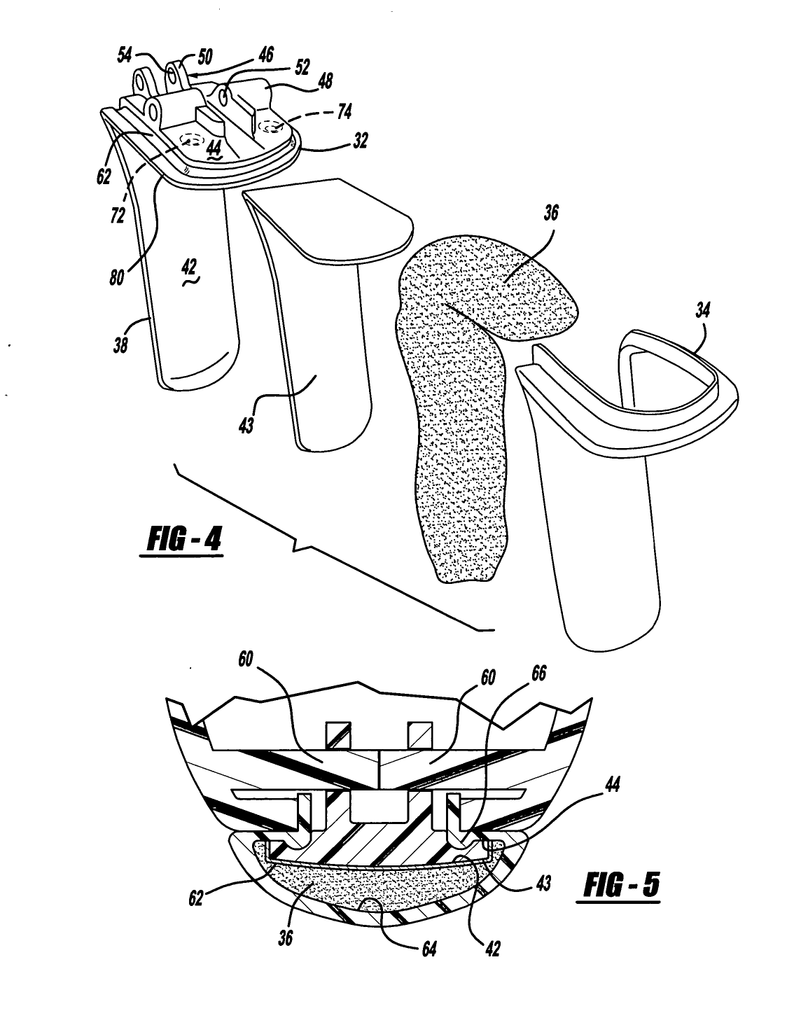

The inner surface 44 includes a mechanism 46 to attach the base 32 to the housing halves 14 and 16. The mechanism 46 includes a plurality of bosses 48 and 50 which include apertures 52 and 54. The apertures 52, 54 receive pins 60 which are unitarily formed with the housing 14, 16. The pins 60 interfits into the apertures 52 and 54 to secure the gel gripping portion 30 into the housing halves 14 and 16 to become an integral portion of the housing 12 (FIG. 5). The inner surface 44 includes a circumferential groove 62 which surrounds the periphery of the base 32. The groove 62 receives a portion of the skin to secure the skin 34 to the base 32 (FIG. 4).

The skin 34 has a desired configuration to mate with the base 32. The skin 34 is slightly larger than the base to form a pocket 64 between the base and the skin 34 to receive the gel material 36. The skin 34 may be vacuum formed to have the desired configuration. The skin 34 is manufactured from a thermosetting silicone rubber. The gel 36 is likewise a thermoset silicone.

The skin includes a peripheral lip 66 which frictionally fits into the circumferential groove 62 on the base 32. The lip 66 has a desired width or thickness so that it is pushed and frictionally fits into the groove 62 sealing the skin 34 with the base 32 to prohibit the gel material 36 from leaking out of the pocket 64 (FIG. 5).

The rigid base 32 and skin 34 are manufactured from materials that do not chemically bond with each other. These members cannot be glued or welded together. The mechanical fastening of the base 32 to the skin 34 enables the use of materials that are more desirable in terms of mechanical properties like elasticity and durability.

The skin 34 has resilient and elastic characteristics. The skin has a pleasing feel to the user's touch. Also, the skin may be stretched. Ordinarily, the transparent skin 34 has a desired thickness. The skin 34 may be produced as an injection molded part with a desired three dimensional configuration.

Thus, the present disclosure provides a gel member housing portion which includes a gripping skin which is in two or more planes angled with respect to one another. Thus, the gel member may have a complex configuration. The present disclosure reduces the amount of gel utilized over the prior art while providing a pleasingly aesthetic appearance as well as a functional grip.

A method of manufacturing the gripping member may be carried out as follows. The skin 34 is injection molded from an elastic material. Additionally, the base 32 is injection molded to form a rigid plastic member. Thus, two dissimilar materials form the two parts. A metallized layer 43 may be secured or adhered to the base 32 if desired. After this has been accomplished, the skin 34 is stretched over the base and the rib 66 is fitted into the circumferential groove 62 in the base 32. The base 32 includes a filling port 72 and a vent port 74 which are identified by phantom lines in FIG. 4. The gel 36 is mixed and injected into the pocket 64 through the filling point 72 between the skin 34 and the base 32. Air vents out through the vent port 74 until it is filled with gel. The assembly may be heated to cure the gel if required. The assembly is held in a fixture to maintain the desired skin shape while the gel cures. After the gel cures, the ports 72 and 74 are sealed, for instance, by heat staking the base. The heat staking enables the filling port and vent port to be closed. The gripping member is then fastened with the housing.

Since the skin 34 is elastic, it can have an undercut shape that wraps around the base 32. The skin 34 is easily removed from its mold due to its elastic properties. The skin 34 is pulled out of the mold. The undercut shape along with the elastic characteristics enable the skin 34 to have a complex configuration.

The description is merely exemplary in nature and, thus, variations that do not depart from the gist of the disclosure are intended to be within the scope of the disclosure. Such variations are not to be regarded as a departure from the spirit and scope of the invention.

What is claimed is:

1. A gripping member comprising:
a base member having a desired configuration with an outer and inner surface, said base member having a desired structural rigidity and a skin receiving member on said base inner surface;
a skin for covering said base, said skin having a desired configuration providing a pocket between said base and skin and said skin having a member for being received in said base inner surface;
a gel material in said pocket between said base and said skin; and
a mechanism on said base for coupling said base with a housing.

2. The gripping member according to claim 1 wherein said base receiving member being a peripheral groove.

3. The gripping member according to claim 2, wherein said skin member being a peripheral lip or bead for frictionally fitting in said peripheral groove.

4. The gripping member according to claim 1, wherein said base has a peripheral flange and said skin surrounds said inner and outer surface of said flange.

5. The gripping member according to claim 1, wherein said mechanism is on said inner surface of said base adapted to couple with a member within the housing.

6. The gripping member according to claim 1, wherein said skin has a mating configuration with said base and being larger than said base for forming said pocket.

7. The gripping member according to claim 1, wherein said base is adapted to form a portion of the housing when coupled with the housing.

8. A power tool comprising:
a housing having an opening;
a motor in said housing;
an output coupled with said motor;
a power source;
an activation member coupled with said motor and said power source for activating and deactivating said motor which, in turn, drives said output;
a gripping member positioned in said opening, said gripping member comprising:
a base member having a desired configuration with an outer and inner surface, said base member having a desired structural rigidity and a skin receiving member on said base inner surface;
a skin for covering said base, said skin having a desired configuration providing a pocket between said base and skin and said skin having a member for being received in said base inner surface;
a gel material in said pocket between said base and said skin; and
a mechanism on said base for coupling said base with said housing in said opening.

9. The power tool according to claim 8, wherein said housing includes a pair of members coupling with one another.

10. The power tool according to claim 9. wherein said base couples with said housing members forming a portion of said housing.

11. The power tool according to claim 8, wherein the outer periphery of said base nests in said housing opening.

12. The power tool according to claim 8 wherein said base receiving member being a peripheral groove.

13. The power tool according to claim 12, wherein said skin member being a peripheral lip or bead for frictionally fitting in said peripheral groove.

14. The power tool according to claim 8, wherein said base has a peripheral flange and said skin surrounds said inner and outer surface of said flange.

15. The power tool according to claim 8, wherein said mechanism is on said inner surface of said base adapted to couple with a member within the housing.

16. The power tool according to claim 8, wherein said skin has a mating configuration with said base and said skin being larger than said base for forming said pocket.

17. The power tool according to claim 8, wherein said base is adapted to form a portion of the housing when coupled with the housing.

18. The power tool according to claim 8, wherein said gripping member includes a first portion and a second portion such that said first and second portions are in different planes.

19. The power tool according to claim 18, wherein said gripping member is continuous and said planes intersect and are angled to one another.

20. A method of manufacturing a gripping member comprising:
molding a skin from an elastic material;
molding a base from a plastic material to form a rigid base;
covering said base with said skin;
adding gel into a pocket between said skin and said base.
